(19) United States
(12) Patent Application Publication
(10) Pub. No.: US 2021/0364214 A1
(43) Pub. Date: Nov. 25, 2021

(54) APPARATUS FOR APPLYING CARBON DIOXIDE IN SOLID FORM TO A TARGET

(71) Applicant: Joseph A. Henry, Calgary (CA)

(72) Inventor: Joseph A. Henry, Calgary (CA)

(21) Appl. No.: 16/879,908

(22) Filed: May 21, 2020

(51) Int. Cl. F25C 5/14; C01B 32/55

(52) U.S. Cl. CPC F25C 5/14; A62D 1/0014; C01B 32/55

(57) ABSTRACT

An apparatus for applying carbon dioxide (CO₂) in solid form to a target comprises an aggregated body production chamber for producing individual solid bodies of CO₂ with defined shape using an endless type conveying member which carries a plurality of receptacles for receiving CO₂ snow and allowing the same to harden therein to form the individual bodies during movement of the receptacles along the upper run before being discharged upon transition to the lower run. The apparatus includes a snow production chamber for producing CO₂ snow, which is in communication with a discharge of the aggregated body production chamber and which comprises its own downstream outlet such that the CO₂ snow acts to convey the individual bodies released from the discharge of the aggregated body production chamber and towards the target.

This application claims the benefit under 35 USC 120 of U.S. Non-Provisional application Ser. No. 16/602,958 filed Jan. 6, 2020, which is incorporated by reference herein.

### FIELD OF THE INVENTION

The present invention relates generally to an apparatus for applying carbon dioxide in solid form to a target, and more particularly to such an apparatus which is configured to form, from carbon dioxide snow, individual bodies of aggregated snow and subsequently to release or discharge such aggregated bodies concurrently with carbon dioxide snow to be applied to the target.

### BACKGROUND

It is generally known that liquid carbon dioxide (CO₂) can be converted to a snow phase or into pellets for subsequent application to a target such as a fire to suppress the same.

Also, as demonstrated by U.S. Pat. No. 6,442,968 by Proni, it is generally known to form, from liquid carbon dioxide, carbon dioxide pellets by enabling the liquid CO₂ to convert to a snow phase and subsequently to compress the snow into pellets.

### SUMMARY OF THE INVENTION

According to an aspect of the invention there is provided an apparatus for applying carbon dioxide in solid form to a target comprising:

a housing having longitudinally spaced apart ends, transversely spaced apart sides, a top and a bottom opposite thereto, wherein the housing defines an enclosed chamber therein;

a conveying member in the enclosed chamber comprising an endless member in the form of a loop supported for rotation about a pair of longitudinally-spaced substantially-parallel generally-horizontal rotational axes so as to form an upper run of the endless member facing towards the top of the housing and a lower run of the endless member facing towards the bottom of the housing;

an inlet duct in communication with the top of the housing at a longitudinally intermediate location between the rotational axes of the conveying member, wherein the inlet duct is configured for fluidic coupling to a pressurized supply of liquid carbon dioxide and to permit conversion thereof into a snow phase upon movement through the inlet duct;

a plurality of receptacles supported on the endless member for rotation therewith in a first rotational direction so as to move across the inlet duct for receiving the carbon dioxide in the snow phase to form a plurality of individual bodies of aggregated carbon dioxide snow;

wherein the upper run is sized in length from the intermediate location to a downstream one of the rotational axes spaced from the intermediate location in the first rotational direction so as to permit the carbon dioxide snow received in the receptacles to harden into said individual bodies before the receptacles transition to the lower run; and

a collection hopper defined by the housing with a bottom hopper opening below the lower run of the conveying member for receiving the individual bodies of aggregated carbon dioxide snow released from the receptacles and subsequently releasing said individual bodies of aggregated carbon dioxide snow for subsequent conveyance to the target.

This provides a simple arrangement for forming individual solid bodies of carbon dioxide which requires minimal input power.

Preferably, the inlet duct extends along an inclined axis which intersects an imaginary line spanning between the rotational axes of the conveying member at an acute angle such that the movement of the carbon dioxide along the inlet duct urges the receptacles to move with the conveying member in the first rotational direction.

Preferably, the acute angle lies in a range between about 5 degrees and about 45 degrees.

In at least one arrangement, the acute angle is about 10 degrees.

Preferably, the conveying member is configured to rotate freely about its rotational axes such that the movement of the carbon dioxide along the inlet duct drives the rotation of the endless member in the first rotational direction.

Preferably, each receptacle comprises a substantially closed bottom end at which the receptacle is connected to the conveying member and an open top end which is spaced from the bottom end by a height of the receptacle, wherein the height of the receptacle is arranged to be substantially equal to a distance between the upper run of the conveying member and the top of the housing such that the top of the housing restricts the carbon dioxide snow containable in each receptacle.

Preferably, the collection hopper is arranged at a downstream end of the conveying member where the upper run transitions to the lower run.

In at least one such arrangement, each receptacle includes an ejector supported therein intermediate a substantially closed bottom end thereof, at which the receptacle is connected to the conveying member, and an open top end of the receptacle, wherein the ejector is movable relative to the bottom end of the receptacle from a lowered position to a raised position to urge the individual body of aggregated carbon dioxide snow out of the receptacle, wherein movement of the ejector from the lowered position to the raised position is actuated by transition of the receptacle from the upper run to the lower run.

In at least one such arrangement, the conveying member comprises a rotary member defining the downstream rotational axis, and wherein the ejector comprises a pushing member disposed inside the receptacle and configured to engage the individual body of aggregated carbon dioxide snow and an actuator pin carried by the pushing member and extending through an opening in the bottom end of the receptacle so as to be presented for contact with the rotary member upon traversal thereof to actuate movement of the ejector from the lowered position to the raised position.

In at least one such arrangement, the ejector is freely movable from the raised position to the lowered position so as to be gravitationally urged thereto when the receptacle is located along the upper run.

Preferably, the apparatus further includes an oxygen injector in operative communication with the housing at the collection hopper and configured for injecting oxygen into the housing.

Preferably, the apparatus further includes an oxygen injector in operative communication with the housing at or adjacent an upstream end of the conveying member and configured for injecting oxygen into the housing.

In such arrangements, preferably the oxygen injector comprises a valve which is fluidically communicated with an external environment of the housing to introduce ambient air having oxygen into the housing.

Preferably, the apparatus further includes an output chamber distinct from the enclosed chamber of the housing and which is in communication with the hopper opening of the collection hopper, wherein the output chamber is configured for fluidic coupling to a supply of pressurized fluid and for guiding contents therefrom across the hopper opening of the collection hopper to a downstream discharge opening defined by the output chamber so as to convey the individual bodies of aggregated carbon dioxide snow therefrom and towards the target.

Preferably, the output chamber is in the form of an elongated duct.

Preferably, the duct formed by the output chamber is longitudinally elongated in the longitudinal direction of the conveying member.

Preferably, the output chamber is configured for fluidic coupling with a pressurized supply of liquid carbon dioxide and to permit conversion thereof into the snow phase upon movement through the output chamber such that carbon dioxide snow formed therein acts to carry the individual bodies of aggregated carbon dioxide snow towards the target.

Preferably, the output chamber is configured for fluidic coupling with the pressurized supply of liquid carbon dioxide with which the inlet duct is also fluidically coupled.

Preferably, the output chamber is configured to receive the liquid carbon dioxide at a higher pressure than the inlet duct so as to provide suction at the hopper opening in movement thereacross.

In the illustrated arrangement, the apparatus further includes a generally horizontally oriented partition wall disposed in the enclosed chamber between the upper and lower runs of the endless member for separating the enclosed chamber into upper and lower ventricles each containing a corresponding one of the runs of the endless member.

According to another aspect of the present invention there is provided an apparatus for applying carbon dioxide in solid form to a target comprising:

an aggregated body production chamber comprising an inlet configured for fluidic coupling to a pressurized supply of liquid carbon dioxide, a snow conversion portion in communication with the inlet and configured to permit conversion of the liquid carbon dioxide into a snow phase, an aggregated body production portion in downstream communication with the snow conversion portion and configured to form from the carbon dioxide in the snow phase a plurality of individual bodies of aggregated carbon dioxide snow, and a discharge portion in downstream communication with the aggregated body production portion and defining an opening for releasing said individual bodies of aggregated carbon dioxide snow for subsequent conveyance to the target; and

a snow production chamber comprising an inlet configured for fluidic coupling to the pressurized supply of liquid carbon dioxide, a snow conversion portion in communication with the inlet and configured to permit conversion of the liquid carbon dioxide into a snow phase, and a discharge opening in communication with the snow conversion portion downstream from the inlet for releasing the carbon dioxide snow for conveyance towards the target, wherein the snow production chamber is in communication with the opening of the discharge portion of the aggregated body production chamber at an upstream location from the discharge opening so as to be configured for guiding the carbon dioxide snow formed in the snow production chamber across the opening of the discharge portion to convey the individual bodies of aggregated carbon dioxide snow with the carbon dioxide snow formed in the snow production chamber towards the target.

This provides an output product comprising carbon dioxide in the form of both snow and solid bodies to be applied to the target.

### BRIEF DESCRIPTION OF THE DRAWINGS

The invention will now be described in conjunction with the accompanying drawings in which:

FIG. 1 schematically shows a cross-sectional view of an apparatus according to the present invention; and

FIG. 2 schematically shows a cross-sectional view along line 2-2 in FIG. 1 but showing only an aggregated body production portion of the apparatus.

In the drawings like characters of reference indicate corresponding parts in the different figures.

### DETAILED DESCRIPTION

The accompanying figures show an apparatus, which is indicated at reference numeral 10, for applying carbon dioxide (CO₂) in solid form to a target such as a fire or a swarm of pests, for example locusts, in respect of which the CO₂ acts as a suppressant.

The apparatus 10 comprises an aggregated body production chamber 12 for producing individual solid bodies of CO₂ with defined shape and a snow production chamber 14 for producing CO₂ snow which is particulate in nature, so as to have indefinite shape, and which generally is less dense than the solid bodies. The apparatus 10 is configured to concurrently discharge the solid bodies and the snow towards the target, which will be better appreciated later.

The apparatus 10 is configured for fluidic coupling to a tank or vessel 3 containing liquid CO₂ under pressure, to receive the liquid CO₂ for subsequent transformation into the solid CO₂ either in the form of the aggregated bodies or the snow.

Turning firstly to the aggregated body production chamber 12, this production chamber of the apparatus 10 generally comprises an inlet 15 configured for fluidic coupling to a pressurized supply of liquid CO₂ defined by the tank 3; a snow conversion portion 17 in communication with the inlet to receive the liquid CO₂ and configured to permit conversion or transformation of the liquid CO₂ into a snow phase in which the CO₂ is in the form of a plurality of crystals; an aggregated body production portion 19 in communication with the snow conversion portion 17 at a downstream location relative to the flow of CO₂ in the chamber 12 and configured to form from the CO₂ snow a plurality of individual bodies of aggregated snow each having definite shape; and a discharge portion 21 downstream of the production portion 19 and defining an opening for releasing the individual bodies for subsequent conveyance to the target. Thus the general process of forming the solid bodies of CO₂ comprises releasing liquid CO₂ under pressure to permit conversion thereof into a snow phase, collection of the CO₂ snow in a manner forming distinct aggregated bodies which are denser than the CO₂ in the snow phase, and releasing the distinct bodies for subsequent conveyance to the target.

The aggregated body production chamber 12 is defined by a housing 24 defining therein an enclosed chamber 25 in which the aggregated bodies are formable. The housing 24 is in the form of a longitudinally-extending rectangular cylindrical tube having opposite top and bottom walls 26A, 26B respectively defining a top and a bottom of the housing, and laterally opposite side walls 28A, 28B defining laterally opposite sides of the housing. The tubular portion of the housing is closed at either end 29, 30 by an enlarged end cap having have divergent top and bottom walls which act to increase a cross-sectional size of the ends of the housing 24, and an end wall spanning between the flared top and bottom walls. Thus the housing 24 itself substantially acts as a duct for guiding the flow of the CO₂ therein from one end such as 29 to the other at 30.

The snow conversion portion 17 is in the form of a duct which is in communication with the top 26A of the housing 24 and which supports at a distal end 33 thereto a coupler defining the inlet 15 which fluidically couples to the pressurized supply of liquid CO₂ indicated at 3. The duct 17 has a larger diameter than that of the coupler 15 and extends over a prescribed length from the distal end 33 to the top 26A of the housing to enable the liquid CO₂ received therein to expand and form CO₂ snow upon discharge from the duct 17 to the housing 24. The snow conversion portion 17 includes an oxygen injector 35 configured for injecting oxygen which is conducive to formation of the snow from CO₂ in a liquid state. In the illustrated arrangement, input pressure of liquid CO₂ flowing into the inlet snow conversion duct 17 is controlled by a distinct pressure control valve 36 in intermediate fluidic communication between the tank 3 and the coupler 15 which simply acts to fluidically connect the tank 3 via a hose to the chamber 12. The conventional pressure control valve 36 is configured to permit passage of liquid CO₂ therethrough and downstream towards the chamber 12 having a pressure of at least a user-selected threshold input pressure value. In other arrangements which are not shown, the coupler and pressure control valve may be a unitary component.

The aggregated body production portion 19 which is downstream to the snow conversion portion 17 includes a conveying member 37 disposed in the enclosed chamber 25 defined by the housing 24. The conveying member 37 comprises an endless member 38 in the form of a loop, such as a chain comprising a plurality of pivotally interconnected elements, supported for rotation about a pair of longitudinally-spaced substantially-parallel generally-horizontal rotational axes 39A, 39B, which are defined by rotary members 40 in the form of sprockets over which the chain is entrained. Thus is formed an upper run 41 of the endless member 38 which faces towards the top 26A of the housing and a lower run 42 of the endless member which faces towards the bottom 26B of the housing.

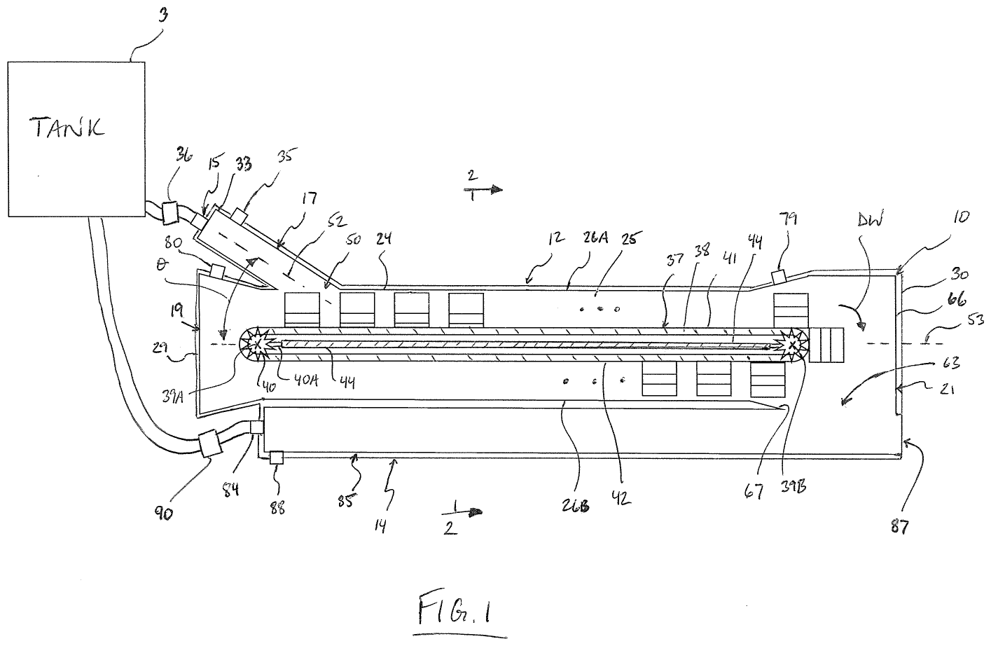

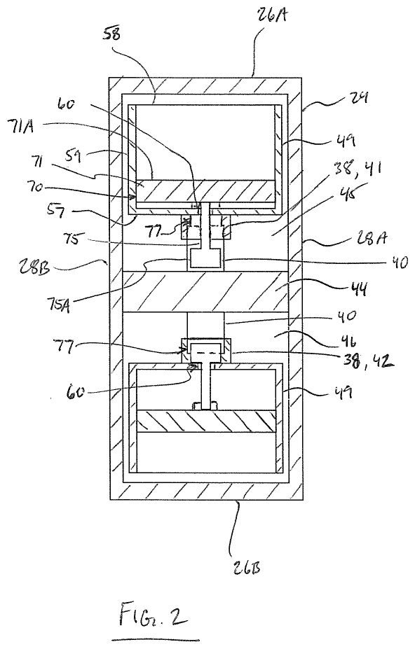

The upper and lower runs 41, 42 are separated within the housing 24 by a partition wall 44 disposed between the runs 41, 42, which spans longitudinally substantially a full distance between the sprockets 40 as shown in FIG. 1 and laterally a full width between the opposite sides 28A, 28B of the housing as shown in FIG. 2. Each sprocket 40 is carried by the partition wall 44 such as by a pair of outwardly projecting legs 40A extending from a respective end of the wall 44 and onto which the sprocket 40 is mounted for rotation about its axis. Thus the partition wall 44 separates the chamber 25 into substantially separate upper and lower ventricles thereof 45, 46 each containing a corresponding one of the runs of the endless-style conveyor.

It will be appreciated that the inlet duct 17 communicates with the housing 24 at a longitudinally intermediate location between the rotational axes 39A, 39B of the conveying member 38, and particularly closer to an upstream one of the axes 39A than to a downstream one of the axes 39B relative, and more specifically substantially at the upstream end of the conveyor 37. Due to the partition wall 44, the inlet duct 17 is in communication with an upper one of the ventricles which is indicated at 45 which can be referred to herein for convenient reference as an input ventricle where CO₂ snow is introduced into the housing chamber 25.

Referring to FIG. 1, the aggregated body production portion 19 includes a plurality of receptacles 49 which are supported on the endless conveying member 38 for rotation therewith in a first rotational direction DW so as to move across an open end 50 of the inlet duct 17 for receiving therefrom the CO₂ snow to form a plurality of individual bodies of aggregated CO₂ snow. As the CO₂ snow is received in the receptacles 49 which are of definite volumetric size and interior shape, they move along the upper run 41 which is sized in length from the intermediate location where the inlet duct 17 communicates with the housing 24 at 50 to a downstream one of the rotational axes 39B that is spaced from the intermediate location (coincident with duct end 50) in the first rotational direction DW so as to permit the CO₂ snow received in the receptacles 49 to harden into the individual bodies before the receptacles 49 transition around the axis 39B to the lower run 42. That is, the CO₂ crystals of the snow phase are enabled to clump together within the receptacles 49 as the receptacles are displaced along the upper run 41. Preferably the distance from the length of the upper run between the intermediate location and the downstream rotational axis 39B is in the order of 2-3 feet as the endless conveyor rotates at a rate controlled by pressure of the CO₂ movement through the chamber 12, which is regulated by the control valve 36 which is set to a pressure value suited for driving rotation of the endless conveying member 38. The receptacles 49 thus define a plurality of movable compartments which define individual volumes for receiving CO₂ snow where the snow can harden or clump into larger bodies, which are of course larger than individual crystals of the particulate CO₂ snow. It will be appreciated that in the illustrated arrangement the receptacles 49 are attached at substantially uniformly spaced positions on the endless member but not all receptacles are shown in FIG. 1 for convenience and clarity of illustration.

It will be appreciated that the inlet duct 17 extends along an inclined axis 52 which intersects an imaginary line 53, spanning between and thus interconnecting the rotational axes 39A, 39B of the conveying member 37, at an acute angle θ with the upstream end of the conveyor such that the flow of CO₂ along the inlet duct 17 and subsequently injected into the upper ventricle 45 urges the receptacles 49 to move with the endless member 38 in the first rotational direction DW. Furthermore, in the illustrated arrangement the conveying member 37 is configured to rotate freely about its rotational axes, in that the rotary members 40 are freewheeling, such that the movement or flow of the CO₂ along the inlet duct and discharge of same into the input ventricle 45 into contact with the receptacles 49 is the sole source of power for driving the rotation of the endless member 38 in the first rotational direction DW. There is no prime mover operatively coupled to the conveying member 37. The acute angle θ lies in a range between about 5 degrees and about 45 degrees, and in the illustrated arrangement it is about 10 degrees, such that the inlet duct 17 can act to simultaneously deposit CO₂ into the receptacles and push them along the upper run 41.

Referring to FIG. 2, each receptacle 49 comprises a substantially closed bottom end 57 at which the receptacle is connected to the endless conveying member 38 and an open top end 58 which is defined by a peripheral wall 59 standing upwardly from the bottom 57. The bottom end 57 is substantially closed in that it is substantially imperforate with the exception of a single opening 60 which will be described further shortly.

The top end 58 of the respective receptacle is spaced from the bottom end 57 by a height of the receptacle which is arranged to be substantially equal to a distance between the upper run 41 of the conveying member and the top 26A of the housing such that the top 58 of the receptacle 49 is in intimate relation with the top 26A of the housing which confines or restricts the CO₂ snow containable in the receptacles. Furthermore, each receptacle 49 is sized in width in the lateral direction of the housing 24 as being substantially equal to a width thereof between the opposite sides 28A, 28B. Thus any CO₂ snow not deposited in the receptacles 49 substantially remains conveyed between receptacles 49 along the upper run 41 by movement of the receptacles 49 along same, but without clumping inside the receptacles 49 in a predictable manner, as the snow is confined to the input ventricle 45 by the partition wall 44 and between each adjacent pair of receptacles.

The aggregated CO₂ snow that has hardened within the receptacles 49 into the distinct bodies is subsequently released from the receptacles upon transition thereof from the upper run 41 to the lower run 42 and into a collection hopper defining the discharge portion 21. The collection hopper 21 which is defined by the housing 24 in turn defines a bottom hopper opening 63 below the lower run 42 of the conveying member for receiving the individual bodies of aggregated CO₂ snow released from the receptacles 49 for releasing the same to be subsequently conveyed to the target. In the illustrated arrangement, the collection hopper 21 is arranged at a downstream end of the conveying member 37 where the upper run 41 transitions to the lower run 42. The collection hopper 21 thus is defined by the end cap defining the housing end 30 and has a first substantially vertical wall 66 defined by the end cap end wall, which extends above the upper run 41, and a second downwardly inclined wall 67 defined by a bottom wall of the end cap. The walls 66,67 are oriented in a downwardly converging condition to define the bottom discharge opening 63 below the lower run 42.

To aid release of the aggregated bodies from the receptacles 49 at a prescribed location, that is at the collection hopper 21, each receptacle 49 includes an ejector 70 comprising a pushing member 71 in the form of a plate supported therein intermediate the bottom end 57 and the open top end 58 of the receptacle. The ejector 70 is movable relative to the bottom end 57 of the receptacle from a lowered position, as shown by the receptacles located along the upper run 41 in FIG. 1 or 2, to a raised position, as shown by the receptacles located along the lower run 42 in FIG. 1 or 2, in which the pushing member 71 is located closer to the top end 58 than in the lowered position. Generally speaking, in the lowered position the pushing member 71 is located substantially at the bottom 57 of the receptacle leaving a maximum amount of volume in the receptacle above the pushing member for receiving CO₂ for subsequent clumping therein. The pushing member 71 in the form of a plate oriented parallel to the bottom 57 of the receptacle thus acts as a receptacle floor which is imperforate. Furthermore, in the illustrated arrangement the pushing member 71 in the raised position is located approximately halfway between the bottom end 57 and the top end 58. Thus in movement from the lowered position to the raised position the ejector 70 acts to urge the individual body of aggregated carbon dioxide snow formed in the receptacle 49 out of same by passing through the open top 58.

The movement of the ejector 70 from the lowered position to the raised position is actuated by transition of the receptacle 49 from the upper run 41 to the lower run 42, as the receptacle traverses a path around the rotary member 40 defining the downstream axis 39B. In the illustrated arrangement, further to the pushing member 71 which is disposed inside the receptacle and which defines an upper surface 71A configured to engage the CO₂ body for pushing the body past the receptacle top end 58, the ejector 70 also comprises an actuator pin 75 carried by the pushing member 71 at its bottom opposite to the surface 71A and extending through an opening 60 in the bottom end 57 of the receptacle so as to be presented outside the receptacle for contact with the downstream rotary member 40 to actuate movement of the ejector 70 from the lowered position to the raised position when the respective receptacle 49 traverses the downstream rotary member 40 at 39B. Accordingly the endless conveying member 38 also includes an opening 77 coincident with the receptacle opening 60 to enable passage of the pin therethrough into a position available for engagement with the rotary member 40. The pin 75 is T-shaped at its bottom 75A so as to act as a stop to limit movement of the pushing member 71 within the receptacle 49 by engaging the bottom 57 of the receptacle outwardly of the opening 60. Moreover, the ejector 70 is freely movable from the raised position to the lowered position so as to be gravitationally urged thereto when the receptacle is located along the upper run. Thus the ejector 70 is very simple.

The aggregated body production chamber 19 further includes a plurality of oxygen injectors 79 and 80 in operative communication with the housing 24 and configured for injecting oxygen into the housing which is conducive to solidification of the CO₂. One of the oxygen injectors indicated at 79 is provided at the collection hopper 21 and more specifically in opposite and spaced relation to the discharge opening 63 so that the collection hopper 21 may contain a higher concentration of oxygen to harden the aggregated bodies prior to discharge from the aggregated body production chamber 12. Another one of the oxygen injectors indicated at 80 is provided at or adjacent an upstream end 39A of the conveying member 37 so as to prefill the receptacles with oxygen before receipt of particulate CO₂ therein from the inlet duct 17.

All of the oxygen injectors of the apparatus 10 such as 35, 79 and 80 comprise valves which are fluidically communicated with an external environment of the housing 24 to introduce ambient air having oxygen into the housing. This simplifies the apparatus 10 so as not to rely on a dedicated supply of oxygen.

Turning now to the snow production chamber 14, this production chamber which is distinct from the chamber 12 generally comprises an inlet 84 configured for fluidic coupling via a coupler to a pressurized supply of liquid CO₂, which in the illustrated arrangement is the same supply as that for the aggregated body production chamber 12 which is indicated at 3 such that the two production chambers are disposed in parallel fluidic communication with the tank 3, a snow conversion portion 85 in communication with the inlet 84 and configured to permit conversion of the liquid CO₂ into the snow phase upon movement therethrough, and a discharge opening 87 in communication with the snow conversion portion downstream from the inlet 84 for releasing the carbon dioxide snow for conveyance towards the target. Furthermore, the snow production chamber 14 is in communication at an upstream location from the discharge opening 87 so as to be configured for guiding the CO₂ snow formed in the snow production chamber 14 across the opening 63 of the discharge portion 21 to convey the individual aggregated CO₂ snow bodies with the CO₂ snow formed in the snow production chamber 14 towards the target. Thus, in relation to the aggregated body production chamber 12, the snow production chamber acts as an output chamber distinct from the enclosed chamber 25 of the housing 24, and in a more general sense the aggregated body production chamber 12, that is configured for fluidic coupling to a supply of pressurized fluid and for guiding contents therefrom across the hopper opening of the collection hopper to a downstream discharge opening 87 defined by the output chamber so as to convey the individual bodies of aggregated CO₂ snow therefrom and towards the target.

In the illustrated arrangement, the snow production chamber 14 as a whole is in the form of an elongated duct which is longitudinally elongated in the longitudinal direction of the conveying member 37 so as to be arranged in parallel adjacent relation thereto, thus allowing the apparatus 10 to occupy less space overall. The snow conversion portion 85 of the snow production chamber 14, which has a larger diameter than that of the coupler 84, extends over a prescribed length therefrom to the opening 63 of the discharge portion 21 to enable the liquid CO₂ received in the snow production chamber to expand and form CO₂ snow upon reaching the hopper opening 63. The downstream discharge opening 87 of the snow chamber 14 is substantially adjacent to the hopper opening 63 but encompasses an axis which is perpendicularly transversely oriented to an axis encompassed by the hopper opening.

The snow production chamber 14 is configured to receive the liquid CO₂ at a higher pressure of about 15 psi than the inlet duct so as to provide suction at the hopper opening 63 in movement of the CO₂ formed in the snow production duct across the hopper opening 63. In the illustrated arrangement this is achieved by a distinct pressure control valve 90 in intermediate fluidic communication between the tank 3 and the coupler 84 which simply acts to fluidically connect the tank 3 via a hose to the chamber 14. The conventional pressure control valve 90 is configured to permit passage of liquid CO₂ therethrough and downstream towards the chamber 14 having a pressure of at least a user-selected threshold input pressure value which corresponds to a prescribed pressure value based on which solid CO₂ can be suitably discharged from the apparatus 10. This threshold pressure value is at least about 15 psi higher than the input pressure of liquid CO₂ flowing into the aggregated body production chamber 12. In other arrangements which are not shown, the coupler and pressure control valve may be a unitary component.

Similarly to the snow conversion portion 17 of the aggregated body production chamber 12, that of the snow conversion chamber 14 includes an oxygen injector 88 configured for injecting oxygen which is conducive to formation of the snow from CO₂ in a liquid state.

In use, the apparatus 10 can be carried by a human operator so as to be handheld or mounted to a carrier transport vehicle such as an airplane which also carries the liquid CO₂ supply 3. The apparatus 10 is substantially self-propelled and is driven by pressure of the CO₂ stored in the supply tank 3 without relying on a prime mover for example to operate the conveying member 37. Upon release of liquid CO₂ into the apparatus 10 into both the aggregated body production and snow production chambers 12, 14 in parallel, that is concurrently, the CO₂ is carried through the respective chambers and transformed into solid form before discharge from the apparatus 10 by the particulate CO₂ in the snow phase towards the target.

The apparatus 10 can be used in a modular array mounted on a transport vehicle such as an airplane since the productions chambers 12, 14 are arranged vertically in-line with one another, with the snow production chamber 14 which acts as an output chamber to convey the aggregated bodies of CO₂ snow towards the target being located below the aggregated body production chamber 12 which at least partially uses gravity to convey the aggregated bodies towards the output chamber. Such an array is scalable in size by disposing a plurality of the apparatuses 10 in side-by-side relation in parallel fluidic connection to a common supply tank by a manifold.

The apparatus 10 is not driven by a self-propelled or manually propelled prime mover and operates solely on the pressure of the CO₂ emitted into the apparatus and thus the apparatus is very simple.

The contents discharged from the apparatus 10 include both CO₂ in the snow phase and CO₂ in the form of individual solid bodies which are denser than the snow and thus less likely to be adversely affected by wind drift upon their trajectory towards the target. In the case of fighting a forest fire from a considerable height above the ground, the individual bodies of clumped CO₂ snow are more likely to reach a centralized area of the fire than the snow which is more likely to reach the target nearer a periphery thereof.

An appendix is included herewith containing additional material about the apparatus described hereinbefore.

The scope of the claims should not be limited by the preferred embodiments set forth in the examples but should be given the broadest interpretation consistent with the specification as a whole.

1. An apparatus for applying carbon dioxide in solid form to a target comprising:
a housing having longitudinally spaced apart ends, transversely spaced apart sides, a top and a bottom opposite thereto, wherein the housing defines an enclosed chamber therein;
a conveying member in the enclosed chamber comprising an endless member in the form of a loop supported for rotation about a pair of longitudinally-spaced substantially-parallel generally-horizontal rotational axes so as to form an upper run of the endless member facing towards the top of the housing and a lower run of the endless member facing towards the bottom of the housing;
an inlet duct in communication with the top of the housing at a longitudinally intermediate location between the rotational axes of the conveying member, wherein the inlet duct is configured for fluidic coupling to a pressurized supply of carbon dioxide and to permit conversion thereof into a snow phase upon movement through the inlet duct;
a plurality of receptacles supported on the endless member for rotation therewith in a first rotational direction so as to move across the inlet duct for receiving the carbon dioxide in the snow phase to form a plurality of individual bodies of aggregated carbon dioxide snow;
wherein the upper run is sized in length from the intermediate location to a downstream one of the rotational axes spaced from the intermediate location in the first rotational direction so as to permit the carbon dioxide snow received in the receptacles to harden into said individual bodies before the receptacles transition to the lower run; and
a collection hopper defined by the housing with a bottom hopper opening below the lower run of the conveying member for receiving the individual bodies of aggregated carbon dioxide snow released from the receptacles and subsequently releasing said individual bodies of aggregated carbon dioxide snow for subsequent conveyance to the target.

2. The apparatus of claim 1 wherein the inlet duct extends along an inclined axis which intersects an imaginary line spanning between the rotational axes of the conveying member at an acute angle such that the movement of the carbon dioxide along the inlet duct urges the receptacles to move with the conveying member in the first rotational direction.

3. The apparatus of claim 2 wherein the acute angle lies in a range between about 5 degrees and about 45 degrees.

4. The apparatus of claim 2 wherein the acute angle is about 10 degrees.

5. The apparatus of claim 2 wherein the conveying member is configured to rotate freely about its rotational axes such that the movement of the carbon dioxide along the inlet duct drives the rotation of the endless member in the first rotational direction.

6. The apparatus of claim 1 wherein each receptacle comprises a substantially closed bottom end at which the receptacle is connected to the conveying member and an open top end which is spaced from the bottom end by a height of the receptacle, wherein the height of the receptacle is arranged to be substantially equal to a distance between the upper run of the conveying member and the top of the housing such that the top of the housing restricts the carbon dioxide snow containable in each receptacle.

7. The apparatus of claim 1 wherein the collection hopper is arranged at a downstream end of the conveying member where the upper run transitions to the lower run.

8. The apparatus of claim 7 wherein each receptacle includes an ejector supported therein intermediate a substantially closed bottom end thereof, at which the receptacle is connected to the conveying member, and an open top end of the receptacle, wherein the ejector is movable relative to the bottom end of the receptacle from a lowered position to a raised position to urge the individual body of aggregated carbon dioxide snow out of the receptacle, wherein movement of the ejector from the lowered position to the raised position is actuated by transition of the receptacle from the upper run to the lower run.

9. The apparatus of claim 8 wherein the conveying member comprises a rotary member defining the downstream rotational axis, and wherein the ejector comprises a pushing member disposed inside the receptacle and configured to engage the individual body of aggregated carbon dioxide snow and an actuator pin carried by the pushing member and extending through an opening in the bottom end of the receptacle so as to be presented for contact with the rotary member upon traversal thereof to actuate movement of the ejector from the lowered position to the raised position.

10. The apparatus of claim 8 wherein the ejector is freely movable from the raised position to the lowered position so as to be gravitationally urged thereto when the receptacle is located along the upper run.

11. The apparatus of claim 1 further including an oxygen injector in operative communication with the housing at the collection hopper and configured for injecting oxygen into the housing.

12. The apparatus of claim 1 further including an oxygen injector in operative communication with the housing at or adjacent an upstream end of the conveying member and configured for injecting oxygen into the housing.

13. The apparatus of claim 11 wherein the oxygen injector comprises a valve which is fluidically communicated with an external environment of the housing to introduce ambient air having oxygen into the housing.

14. The apparatus of claim 1 further including an output chamber distinct from the enclosed chamber of the housing and which is in communication with the hopper opening of the collection hopper, wherein the output chamber is configured for fluidic coupling to a supply of pressurized fluid and for guiding contents therefrom across the hopper opening of the collection hopper to a downstream discharge opening defined by the output chamber so as to convey the individual bodies of aggregated carbon dioxide snow therefrom and towards the target.

15. The apparatus of claim 14 wherein the output chamber is in the form of an elongated duct.

16. The apparatus of claim 15 wherein the duct formed by the output chamber is longitudinally elongated in the longitudinal direction of the conveying member.

17. The apparatus of claim 14 wherein the output chamber is configured for fluidic coupling with a pressurized supply of liquid carbon dioxide and to permit conversion thereof into the snow phase upon movement through the output chamber such that carbon dioxide snow formed therein acts to carry the individual bodies of aggregated carbon dioxide snow towards the target.

18. The apparatus of claim 17 wherein the output chamber is configured for fluidic coupling with the pressurized supply of liquid carbon dioxide with which the inlet duct is also fluidically coupled.

19. The apparatus of claim 17 wherein the output chamber is configured to receive the liquid carbon dioxide at a higher pressure than the inlet duct so as to provide suction at the hopper opening in movement thereacross.

20. The apparatus of claim 1 further including a generally horizontally oriented partition wall disposed in the enclosed chamber between the upper and lower runs of the endless member for separating the enclosed chamber into upper and lower ventricles each containing a corresponding one of the runs of the endless member.

21. An apparatus for applying carbon dioxide in solid form to a target comprising:
an aggregated body production chamber comprising an inlet configured for fluidic coupling to a pressurized supply of liquid carbon dioxide, a snow conversion portion in communication with the inlet and configured to permit conversion of the liquid carbon dioxide into a snow phase, an aggregated body production portion in downstream communication with the snow conversion portion and configured to form from the carbon dioxide in the snow phase a plurality of individual bodies of aggregated carbon dioxide snow, and a discharge portion in downstream communication with the aggregated body production portion and defining an opening for releasing said individual bodies of aggregated carbon dioxide snow for subsequent conveyance to the target; and
a snow production chamber comprising an inlet configured for fluidic coupling to the pressurized supply of liquid carbon dioxide, a snow conversion portion in communication with the inlet and configured to permit conversion of the liquid carbon dioxide into a snow phase, and a discharge opening for releasing the carbon dioxide snow for conveyance towards the target, wherein the snow production chamber is in communication with the opening of the discharge portion of the aggregated body production chamber at an upstream location from the discharge opening so as to be configured for guiding the carbon dioxide snow formed in the snow production chamber across the opening of the discharge portion to convey the individual bodies of aggregated carbon dioxide snow with the carbon dioxide snow formed in the snow production chamber towards the target.
